(19) United States
(12) Patent Application Publication
(10) Pub. No.: US 2023/0146242 A1
(43) Pub. Date: May 11, 2023

(54) JEANS MANUFACTURING METHOD USING DIGITAL PRINTING

(71) Applicant: JUNTEXGLOBAL, Daegu (KR)

(72) Inventor: Jun Sung PARK, Daegu (KR)

(73) Assignee: JUNTEXGLOBAL, Daegu (KR)

(21) Appl. No.: 17/545,461

(22) Filed: Dec. 8, 2021

(30) Foreign Application Priority Data
Nov. 5, 2021 (KR) 10-2021-0151252

(51) Int. Cl. A43D 8/12; B41M 5/00; D06P 5/00

(52) U.S. Cl. CPC A43D 8/12; B41M 5/0041; D06P 5/001

(57) ABSTRACT

A jeans manufacturing method is proposed. The jeans manufacturing method includes: preparing a fabric for manufacturing jeans; patterning in which a boundary line of each part constituting the jeans is drawn; cutting the fabric along patterns drawn in the patterning; sewing a plurality of fabrics cut along the patterns in the cutting to form a shape of the jeans; and mounting buttons and a zipper to the jeans formed through the sewing.

The present application claims priority to Korean Patent Application No. 10-2021-0151252, filed November 5^{th}, 2021, the entire contents of which is incorporated herein for all purposes by this reference.

### BACKGROUND OF THE INVENTION

### Field of the Invention

The present invention relates generally to a jeans manufacturing method using digital printing. More particularly, the present invention relates to a jeans manufacturing method using digital printing in which a sewing guide line is drawn in each pattern drawn in patterning to improve the accuracy of sewing work, and a design to be applied to each part of jeans is drawn in each pattern constituting the jeans to be digitally printed on a fabric, thereby simply printing the design of the entirety of the jeans and reducing the manufacturing time and cost of the jeans.

### Description of the Related Art

Generally, a pattern in all clothing manufacturing fields including jeans has the same concept as a design drawing in architectural fields and means a basic design.

In order to manufacture jeans, patterns that constitute the jeans are required to be first designed.

Through a modification process in patterning, a problem such as the deformation of finished clothing which may occur in a jeans manufacturing process is solved and the correction of a sewing line according to actual measurement is performed.

Conventionally, a stiff paper or film is used and cut along patterns designed in patterning.

A plurality of cut paper patterns is fixed on a fabric, the outlines of the patterns are drawn on the fabric by using chalk or a fabric pen, and then the fabric is cut. Since the above work is done by hand, considerable time and cost are required depending on the skill levels of workers.

In addition, in the case of the conventional technology, in the patterning, a sewing line for sewing is not drawn separately. Accordingly, since the sewing is performed without the sewing line, the shape of jeans formed through the sewing may not be constant.

Meanwhile, in the conventional technology, when manufacturing jeans, physical texture treatment and post-processing steps are performed to give design effects such as wear and tear to the jeans. In this case, the texture treatment is performed by partially dyeing the jeans by using dyes or by rubbing an abrasive as a sanding device against the jeans.

In order to perform such a work, several devices are involved, and considerable time and cost are required for post-processing.

Recently, many methods of digitally printing a design on a fabric have been developed, but such methods have various limitations.

In a conventional digital printing method, the same pattern is repeatedly printed on finished jeans, or a small design is applied to a partial position of the jeans, but it is impossible to apply each different design to the entirety of the jeans.

In addition, the finished jeans have an uneven surface, so when designs are digitally printed on the finished jeans, the perfection level of the printed designs is lowered, and the delicate expression of the designs is also impossible.

Accordingly, it is urgently required to develop a new jeans manufacturing method in which the accuracy of sewing is improved, the design of entire jeans is easily printed, and jeans manufacturing time and cost are reduced.

### Document of Related Art

(Patent Document 1) Korean Patent Application Publication No. 10-2009-0060471

### SUMMARY OF THE INVENTION

Accordingly, the present invention has been made keeping in mind the above problems occurring in the related art, and the present invention is intended to propose a jeans manufacturing method using digital printing in which a design to be applied to each part of the jeans is digitally printed on the fabric so as to have the same visual effect as post-processing the fabric in a physical manner.

In addition, the present invention is intended to propose a jeans manufacturing method using digital printing in which a design to be applied to each part of the jeans is drawn in each pattern constituting the jeans and is digitally printed on the fabric such that complex and delicate designs can be expressed.

Furthermore, the present invention is intended to propose a jeans manufacturing method using digital printing in which a design to be applied to each part of the jeans is digitally printed on the fabric so as to reduce the manufacturing time and cost of the jeans.

Additionally, the present invention is intended to propose a jeans manufacturing method using digital printing in which a sewing guide line is drawn in each pattern drawn in patterning so as to improve the accuracy of sewing work.

In order to achieve the above objective, according to one aspect of the present invention, there is provided a jeans manufacturing method using digital printing, the method including: preparing a fabric for manufacturing jeans; patterning in which a boundary line of each part constituting the jeans is drawn; cutting the fabric along patterns drawn in the patterning; sewing a plurality of fabrics cut along the patterns in the cutting to form a shape of the jeans; and mounting buttons and a zipper to the jeans formed through the sewing.

In addition, the patterning of the present invention may be performed on a computer through a CAD program.

Furthermore, in the patterning of the present invention, a sewing guide line may be drawn in each of the drawn patterns to improve accuracy of the sewing.

Additionally, in the patterning of the present invention, a design to be applied to each part of finished jeans may be drawn in each of the drawn patterns.

In addition, the jeans manufacturing method of the present invention may further include: a digital printing of digitally printing each of the patterns having the design drawn in the patterning on the fabric, the digital printing being performed between the patterning and the cutting, wherein the design may be printed on the entirety of the jeans through the digital printing so as to reduce manufacturing time and cost of the jeans.

In the jeans manufacturing method according to the present invention, a design to be applied to each part of jeans is digitally printed on the fabric, thereby having the same visual effect as post-processing the fabric in a physical manner.

In addition, according to the present invention, a design to be applied to each part of the jeans is drawn in each pattern constituting the jeans and is digitally printed on the fabric, thereby expressing complex and delicate designs.

Furthermore, according to the present invention, a design to be applied to each part of the jeans is digitally printed on the fabric, thereby reducing the manufacturing time and cost of the jeans.

Additionally, according to the present invention, a sewing guide line is drawn in each pattern drawn in patterning, thereby improving the accuracy of sewing work.

In addition to the above-described effects, the specific effects of the present invention will be described together with the following description of the details for embodying the invention.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 is a flowchart of a jeans manufacturing method according to the present invention;

FIG. 2 is a view illustrating patterning according to the present invention; and

FIG. 3 is a view illustrating jeans manufactured through the jeans manufacturing method according to the present invention.

### DETAILED DESCRIPTION OF THE INVENTION

Hereinafter, the embodiment of the present document will be described with reference to the accompanying drawings. However, this is not intended to limit the technology described in this document to a specific embodiment, and it should be understood that various modifications, equivalents, and/or alternatives of the embodiment of this document are included. In connection with the description of the drawings, like reference numerals may be used for like components.

In addition, expressions such as “first” and “second” used in this document may modify various elements regardless of order and/or importance, and are used only to distinguish one element from another element, but do not limit the associated components. For example, “a first part” and “a second part” may represent different parts regardless of order or importance. For example, without departing from the scope of the claims described in this document, a first component may be referred to as a second component, and similarly, the second component may be referred to as the first component.

In addition, terms used in this document are used only to describe the specific embodiment, and may not be intended to limit the scope of other embodiments. A singular expression may include a plural expression unless the context clearly dictates otherwise. Terms used herein, including technical or scientific terms, may have the same meanings as commonly understood by those skilled in the art described in this document. Among the terms used in this document, terms defined in a general dictionary may be interpreted as the same or similar meanings as meanings in the context of the related art, and unless explicitly defined in this document, should not be interpreted as ideal or excessively formal meanings. In some cases, even terms defined in this document cannot be construed to exclude the embodiment of the present document.

The present invention relates to a jeans manufacturing method using digital printing.

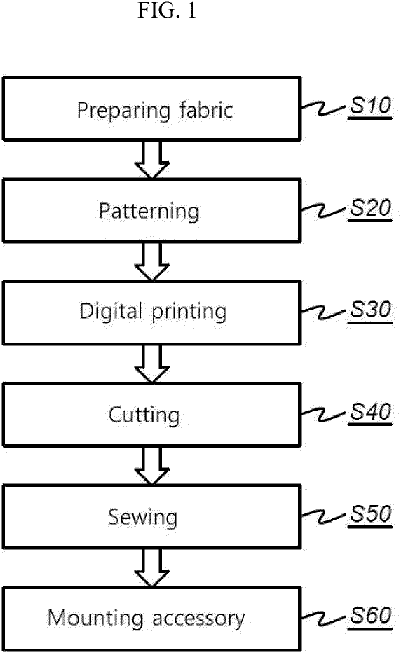

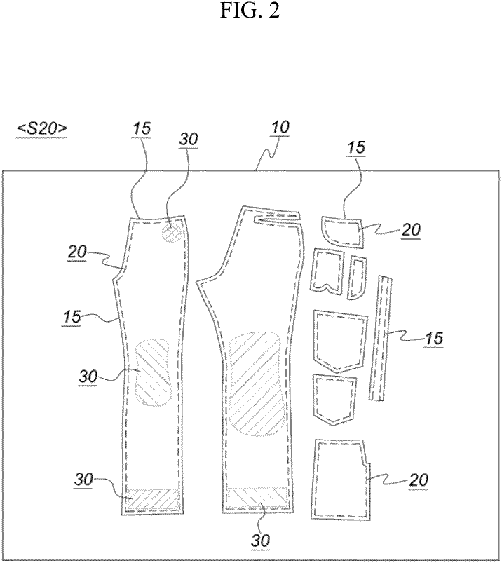

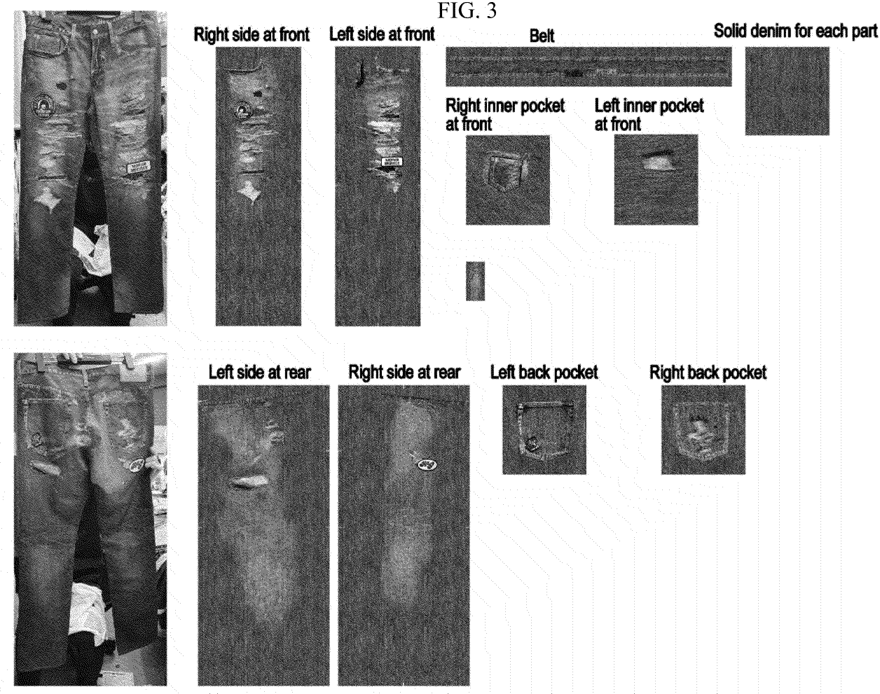

FIG. 1 is the flowchart of a jeans manufacturing method according to the present invention, FIG. 2 is a view illustrating patterning according to the present invention, and FIG. 3 is a view illustrating jeans manufactured through the jeans manufacturing method according to the present invention.

The jeans manufacturing method of the present invention will be described with reference to FIGS. 1 to 3.

The jeans manufacturing method according to the present invention is composed of a total of six steps: preparing a fabric, patterning, digital printing, cutting, sewing, and mounting accessories.

Preparing a fabric is the step of preparing a fabric for manufacturing jeans.

The patterning is the step of drawing the boundary line of each part constituting the jeans.

A pattern in all clothing manufacturing fields including jeans has the same concept as a design drawing in an architectural field, and in the present invention, means drawing the design of jeans.

In order to manufacture jeans, first of all, patterns constituting the jeans are required to be designed.

Problems such as the deformation of finished clothing which may occur in a jeans manufacturing process and the correction of a sewing line according to actual measurement are solved through a modification process in the patterning.

Conventionally, a stiff paper or film is used and cut along patterns designed in patterning.

A plurality of cut paper patterns is fixed on a fabric, the outlines of the patterns are drawn on the fabric by using chalk or a fabric pen, and then the fabric is cut. Since the above work is done by hand, considerable time and cost are required depending on the skill levels of workers.

In addition, in the conventional patterning, the sewing line for sewing is not drawn separately. Accordingly, since the sewing is performed without the sewing line, the shape of jeans formed through the sewing may not be uniform.

Such a problem of the conventional technology is solved by the patterning according to the present invention.

The patterning according to the present invention is performed on a computer through a CAD program.

That is, making a paper pattern according to a pattern is not required, and time and cost required in this process can be saved.

Drawing patterns on a computer by using a CAD program is more accurate in numerical values and lines than working by hand. Additionally, when the patterning is performed on a computer, there is no risk of the loss of patterns and it is convenient to manage the patterns.

In addition, according to the present invention, a sewing guide line is drawn in each of the drawn patterns, so there is the advantage of improving the accuracy of sewing work to be performed later.

A work performs the sewing work along the sewing guide lines drawn in the patterning, thereby reducing mistakes and manufacturing jeans having a uniform shape.

Meanwhile, in the case of the conventional technology, a separate post-processing is performed on finished jeans such that designs are applied to a fabric.

The post-processing is the step of performing physical texture treatment on the fabric so as to give design effects such as wear, tears, and a dyed state to the fabric made in the shape of the jeans.

The texture treatment is performed by partially dyeing the jeans by using dyes or by rubbing an abrasive mounted to a sanding device against the jeans.

Particularly, in order to dye the entirety or part of jeans, the jeans are required to go through an ionization process, a preheating process, a dyeing process, a water washing process, a dehydration process, and a drying process.

In order to perform such a post-processing step, several devices are involved, and considerable manufacturing time and cost are required.

Accordingly, according to the present invention, in the patterning, a design to be applied to the jeans is drawn in each pattern and is digitally printed on the fabric of the jeans, and thus the conventional problems are solved.

According to the present invention, a design to be applied to each part of the jeans is digitally printed on the fabric so as to have the same visual effect as post-processing the fabric in a physical manner.

That is, even without going through the post-processing performed in the conventional technology, a design is digitally printed on a fabric to express jeans having the same visual design as a design obtained after the post-processing.

The physical processing of the post-processing is not performed, so the manufacturing time and cost of jeans are saved.

However, in the digital printing method used in the conventional technology, the same pattern is repeatedly applied to a fabric or a small design is applied to a partial position of finished jeans.

That is, it is impossible to apply each of different designs to the entirety of the jeans.

This is because due to the unevenness of the surface of the finished jeans due to steps on the surface, the perfection level of printed designs during digital printing work is lowered and the delicate expression of the designs is also impossible.

To solve such problems, according to the present invention, in the patterning, a design to be applied to each part of the jeans is drawn in each pattern.

In the patterning, the boundary line, the sewing guide line, and a design to be applied to the jeans is drawn in each part constituting the jeans.

That is, instead of applying a design to jeans through a post-processing step after completing the jeans, a design is drawn in each pattern in the patterning and the fabric having the pattern on which the design is drawn is printed out to make the jeans.

When such a patterning is completed, the digital printing is performed.

The digital printing is performed between the patterning and the cutting.

The digital printing is the step of digitally printing each of the patterns having the design drawn in the patterning on the fabric.

In the present invention, the designs can be printed on the entirety of the jeans through the digital printing so as to reduce the manufacturing time and cost of the jeans.

The designs are digitally printed on the fabric so as to have the same visual effect as post-processing the fabric in a physical manner. Additionally, complex and delicate designs can be expressed.

Next, the cutting is performed.

In the cutting, the fabric printed through the digital printing is cut along the patterns drawn in the patterning.

After cutting the fabric along the patterns, the sewing in which fabrics cut along the patterns are connected to each other is performed.

In the sewing, the plurality of fabrics cut along the patterns in the cutting is sewn to form the shape of the jeans.

Finally, the mounting of accessories is performed.

After the mounting of accessories such as buttons and a zipper to the jeans formed through the sewing, the jeans are completed.

The present invention relates to the jeans manufacturing method using digital printing. More particularly, the present invention relates to the jeans manufacturing method using digital printing in which the sewing guide line is drawn in each pattern drawn in patterning to improve the accuracy of sewing work, and a design to be applied to each part of jeans is drawn in each pattern constituting the jeans to be digitally printed on a fabric, thereby simply printing the design of the entirety of the jeans and reducing the manufacturing time and cost of the jeans.

In the above description, although the exemplary embodiment of the present invention has been shown and described, the present invention is not limited to the specific embodiment described above, but may have variously modified embodiments by those skilled in the art to which the present invention pertains without departing from the gist of the present invention claimed in the claims. Such modified embodiments are not to be construed individually from the spirit or prospect of the present invention.

What is claimed is:

1. A jeans manufacturing method comprising:
preparing a fabric for manufacturing jeans;
patterning in which a boundary line of each part constituting the jeans is drawn;
cutting the fabric along patterns drawn in the patterning;
sewing a plurality of fabrics cut along the patterns in the cutting to form a shape of the jeans; and
mounting buttons and a zipper to the jeans formed through the sewing.

2. The method of claim 1, wherein the patterning is performed on a computer through a CAD program.

3. The method of claim 1, wherein in the patterning, a sewing guide line is drawn in each of the drawn patterns to improve accuracy of the sewing.

4. The method of claim 1, wherein in the patterning, a design to be applied to each part of finished jeans is drawn in each of the drawn patterns.

5. The method of claim 4, further comprising:
a digital printing of digitally printing each of the patterns having the design drawn in the patterning on the fabric, the digital printing being performed between the patterning and the cutting,
wherein the design is printed on entirety of the jeans through the digital printing so as to reduce manufacturing time and cost of the jeans.
